(19) United States
(12) Patent Application Publication
(10) Pub. No.: US 2003/0196208 A1
(43) Pub. Date: Oct. 16, 2003

(54) Audio/video distribution system

(76) Inventor: Stephen R. Jacobson, Miami Beach, FL (US)

Correspondence Address: Mark D. Bowen, Stearns Weaver Miller, et al., Suite 1900, 200 East Broward Boulevard, Fort Lauderdale, FL, 33301, US

(21) Appl. No.: 10/409,014

(22) Filed: Apr. 8, 2003

Related U.S. Application Data
(63) Continuation of application No. 09/683,516, filed on Jan. 11, 2002, now abandoned.
(60) Provisional application No. 60/319,011, filed on Nov. 25, 2001.

(51) Int. Cl. H04N 7/173

(52) U.S. Cl. 725/116; 725/107; 725/127

(57) ABSTRACT

An audio/video distribution system that is cost-effective, highly flexible, and capable of being used over an extended area and without the need for a centralized switching and distribution mechanism. The audio/video distribution system includes a distribution cable, at least one audio/video transmitter, at least one receiver, and a control director. The transmitter is configured to receive signals from at least one audio/video source while the receiver is connected to the distribution cable and configured to receive signals from the distribution cable. The control director is connected to the distribution cable and configured to control the transmitter and receiver.

### CROSS REFERENCE TO RELATED APPLICATIONS

This application is a continuation of U.S. patent application Ser. No. 09/683,516, filed Jan. 11, 2002, which claims the benefit of U.S. Provisional Patent Application Ser. No. 60/319,011 filed Nov. 25, 2001.

### BACKGROUND OF INVENTION

a. Field of the Invention

The present invention relates generally to audio and video distribution systems, and more particularly, to an audio/video distribution system that is configured to connect audio and video sources to video users without the need for a centralized switching and distribution apparatus.

b. Description of the Prior Art

It is often necessary to connect, switch, and properly route audio and video signals from sources, such as video cameras with audio capabilities and video tape recorders, for example, to end users over an extended area. The need for such switching capabilities exists in a wide variety of applications including television and video production, surveillance systems, home entertainment systems, and a myriad of other applications where audio and video signals must be connected and properly routed.

In the past, this connection has been performed with centralized switching arrangements. Such switching arrangements typically utilize a switching matrix that has audio/video inputs, audio/video output, and a manual or automated arrangement for connecting the inputs to the outputs.

Existing systems focus primarily on providing centralized video switching arrangements. For example, U.S. Pat. No. RE34,611, issued to Fenwick et al, discloses a system wherein video programs are transmitted to independently controlled video monitors via a centralized switching matrix. U.S. Pat. No. 6,160,455, issued to Hayashi et al., describes the switching of video programs using a computer local area network for the program setup and selection, and utilizes a centralized video distributor and routing switcher to distribute the audio/video signals. U.S. Pat. No. 5,889,775, issued to Sawicz et al., describes an entertainment server connected to video distribution boxes through the use of one or more crosspoint (centralized) switches. U.S. Pat. No. 6,104,414, issued to Odryna et al., describes an improved digital centralized switching matrix. U.S. Pat. No. 6,160,455, issued to Hayashi et al., describes the switching of video programs using a computer local area network for the program setup and selection, and utilizes a centralized video distributor and routing switcher to distribute the audio/video signals. U.S. Pat. No. 5,889,775, issued to Sawicz et al., describes an entertainment server connected to video distribution boxes through the use of one or more cross point (centralized) switches. U.S. Pat. No. 6,104,414, issued to Odryna et al., describes an improved digital centralized video distribution hub that utilizes a switching matrix. U.S. Pat. No. 5,455,619, issued to Truckenmiller et al., describes a video distribution system designed to distribute specific video programs to rooms (a hotel/motel type of lodging arrangement) using electronic tags, a computerized switching arrangement, and a centralized video distribution point.

Although a variety of attempts have been made to improve centralized audio/video switching arrangements, a number of shortcomings and distinct disadvantages still exist in such systems. Initially, it is seen that existing audio/video distribution systems require that the audio/video signal from each source be routed over a single cable path back to the centralized switching arrangement. As such, a single cable path must then be utilized to send the audio/video signals from the switching arrangement to the user of the audio/video signal. This results, unfortunately, in a complex and often times, cumbersome, plurality of cables required to convey these audio/video signals. If the audio/video sources and users are in close proximity to each other, this plurality of cables can potentially become quite difficult to manage. On the other hand, however, the plurality of cables are very difficult to manage and very costly to install and maintain in instances where the audio/video sources and users are not in close proximity to each other, as in the case of a building video surveillance system, for example.

Additionally, once the audio/video sources are in place, moving them to a new location requires installing new cables and identifying new electrical power sources for them. This results in an inflexible and expensive system that is inefficient, cumbersome, and difficult to install, maintain, and upgrade.

The general concept of a distributed audio/video switching system has been implemented in cable television systems in the form of distributed switching. Cable television uses a form of distributed switching, whereby different audio/video sources are frequency multiplexed onto the cable. This is accomplished by mixing the baseband audio/video signal with a carrier frequency in a non-linear manner. This causes the baseband audio/video signal to be frequency shifted to a higher-frequency band (or channel) and is accomplished by utilizing a transmitter. By using different carrier frequencies, multiple audio/video signals can be placed on the cable and “stacked” in frequency. To select an audio/video source, a receiver is then tuned to the proper carrier frequency. A number of existing systems utilize this principle to do audio/video switching. For example, U.S. Pat. No. 5,592,482, issued to Abraham, uses frequency multiplexing to distribute multiple video sources to multiple video users. Similarly, U.S. Pat. No. 5,767,894, issued to Fuller et al., discloses a system using a RF (frequency multiplexed) video distribution system to send video information from the video servers to the room TV sets. In this patent, the video distributions system may optionally include a plurality of coaxial cables or optical fibers (using a centralized switching arrangement). U.S. Pat. No. 5,818,512, issued to Fuller also uses a frequency multiplexed switching arrangement.

Although frequency multiplexing solves some of the cable management and cost issues of the centralized switching arrangements, it also has a number of shortcomings and disadvantages that have not been addressed. Naturally, the high cost of existing frequency multiplexing systems is of substantial concern. A very stable carrier frequency source and multiplex transmitter is required for each video source. The carrier frequency must be very stable because if it changes, the audio/video signal transmitted can interfere with an audio/video signal on an adjacent channel. In a surveillance application, where video sources may be in outside locations, the transmitter will be subject to inclement weather conditions and the stability of the carrier frequency can be influenced by external conditions such as temperature and humidity. Also, the transmitter itself is costly and complex, and can result in a variety of maintenance problems. Furthermore, such systems are one-way systems and it is not possible to control a specific video source. The audio/video sources all transmit on their specific channels, and it is up to the audio/video user to decide which source to use. This increases the cost and complexity of the receiving equipment, which must decode the particular channel of interest.

Another existing way to accomplish audio/video distribution is to store the audio/video information on computer disk, and send this information over a computer bus or local area network to another computer, which then decodes the digital audio/video to analog audio/video and sends it to a display to be seen. This type of distribution is described in U.S. Pat. No. 6,133,908 issued to Sciobra et al. This system is not a real-time system, where live audio/video from sources is displayed as live audio/video to users. Also, having processors to encode audio/video to digital and then decode the audio/video so that it may be displayed is extremely costly and trouble-prone. Furthermore, transmitting digital audio/video over long distances requires special networking technology that is difficult to manage and costly to install and maintain.

A number of other cable distribution systems have been developed by utilizing Ethernet and SCSI (Small Computer System Interface) technology. The information that flows over the cable is digital. This is disclosed in U.S. Pat. No. 5,550,584 issued to Yamada. Although such systems use digital signals to control the respective transmitters and receivers on the cable, the actual information (the audio/video information) is stored in analog form and must be converted to digital to send over these cables. Unfortunately, these systems are fully digital systems relying on complex protocols to coordinate the devices connected to the cable as well as complex transmitters and receivers used to send and receive the audio/video information. An illustration of a fully digital distribution system is shown in FIG. 10. FIG. 10 illustrates two video sources (VS1 and VS2) sending video into a single monitoring station. An analog video signal VS1 320 is sent from a Video Source 42 into a device 350 that converts the analog signal into a sampled digital representation 333. This is usually called an A/D device or a frame grabber (since it digitizes an entire video frame at a time) and produces a pixilated frame 334 (because the video frame is now broken up into picture elements (or pixels), with a resolution (pixels/inch) specified by the A/D device 350. The greater the video resolution, the larger number of pixels would exist in the pixilated frame. For example, if the desired resolution were 480 pixels wide by 320 pixels high (a typical low-medium resolution image, such as used on digital cell phones that capture video), the pixilated frame would consist of 153,600 pixels. If 3 bytes of data are used for each pixel (1 byte for red, 1 byte for green, 1 byte for blue—the basic primary colors), the size of the pixilated frame in bytes would be 1,228,800 bytes. This frame is stored in a frame buffer 352. A general-purpose digital computer composed of a CPU 351, memory 353, and a network interface 354 controls the acceptance and storing of the pixilated frame. It also controls the movement of the pixilated frame into the network interface, and well as provide network coordination and control of the pixilated image transmission to the monitor. If compression is used, this digital computer also performs the compression. Without compression, the data rates become very large. The standard real-time video frame rate is 1 frame every 1/15 of a second (NTSC standard). This means that a data rate of approximately 25 megabytes/second (including 35% data communications protocol overhead) must be sustained through the digital computer. Breaking that into bits/second (the standard measure for network data traffic, the data traffic rate across the network of approximately 200 megabits per second would be realized. This can be reduced by digital video compression, but a cost of significantly increased computer size (and power consumption) and significant delays in performing the compression. The digital transmission packets 342 from the VS1 network interface 354 are shown. Transmitter VS2 is similar to Transmitter VS1, with its VS2 frame 326 being sent into the A/D 350 from the video source 42. 336, 337, and 344 are the digitized video, the pixilated frame, and the digital data packet from video source VS2 326. These digital data packets 342 and 344 are received by a general-purpose digital computer located in the monitoring station. This general-purpose computer is composed of similar elements 354, 352, 353, and 351 to the transmitters. The difference here is a D/A or video device 370 that converts pixilated video frames 334 into sampled frames, reconstitutes the sampled video into continuous video, and sends the video frames to a plurality of video users 48. 330 is the continuous video for VS1, and 332 is the continuous video for VS2. Continuous video is required to display correctly on a video monitor. A comparison of a digital distribution system to the present invention is summarized in Appendix A.

Another cable-oriented distributed switched component audio/video system is disclosed in U.S. Pat. No. 4,581,645 issued to Beyers, Jr. This system is mainly an interconnection system for an audio and video component entertainment system. As such, the cable and its electronic components are designed for short distances where distributed computer control is not a factor. This system is not intended for audio/video sources and users over an extended geographic area, such as a large room, multiple rooms, or building where the control, audio, video, and power must be kept to a single continuous cable.

Accordingly, there is an established need in the art for a distributed audio/video system that is cost effective, highly flexible, and capable of being used over an extended area

### SUMMARY OF INVENTION

The present invention is directed to a low cost, highly flexible audio/video distribution system configured to connect audio and video sources to audio and video users without the need for a centralized switching and distribution mechanism.

The term “audio/video” as used herein means audio or video or a combination of audio and video. Accordingly, any reference to audio/video should be understood to refer to audio only, video only, or a combination of audio and video.

An object of the present invention is to provide an audio/video distribution system that offers a substantially low-cost solution to connecting audio/video sources and users. This is accomplished using multiplexed analog video and audio and a simple control system.

A further object of the present invention is to provide an audio/video distribution system wherein the audio/video transmitters that.place the audio/video sources onto the cable are relatively simple and inexpensive to manufacture and maintain.

Another object of the present invention is to provide an audio/video distribution system wherein the audio/video receivers extracting audio/video signals from the cable are also simple and inexpensive to manufacture and maintain.

An additional object of the present invention is to provide an audio/video distribution system utilizing control circuitry with low speed digital components in a cost-effective manner.

Yet another object of the present invention is to provide an audio/video distribution system that eliminates the need to have individual cables connecting users and sources back to a centralized switch.

A further object of the present invention is to provide an audio/video distribution system wherein the cable is a single cable assembly that is routed along a path common to the video sources and users.

Another object of the present invention is to provide an audio/video distribution system including simple and inexpensive diagnostic tools for maintenance and monitoring of the cable and the attached transmitters and receivers.

In accordance with a first aspect of the invention, an audio/video distribution system is provided including a distribution cable, at least one audio/video transmitter, at least one receiver, and a control signal generator. The transmitter is configured to receive analog signals from at least one audio/video source and place these signals on the cable, while the receiver is connected to the distribution cable and configured to receive the analog signals from the distribution cable. The control signal generator is connected to the distribution cable and configured to control the transmitter and receiver.

These and other objects, features, and advantages of the present invention will become more readily apparent from the attached drawings and the detailed description of the preferred embodiments, which follow.

### BRIEF DESCRIPTION OF DRAWINGS

The preferred embodiments of the invention will hereinafter be described in conjunction with the appended drawings provided to illustrate and not to limit the invention, where like designations denote like elements, and in which:

FIG. 1 is an illustrative schematic view showing a preferred embodiment of the overall layout of the present invention;

FIG. 2A is an illustrative schematic view showing a preferred embodiment of a battery powered power module of the present inventions;

FIG. 2B is an illustrative schematic view showing a preferred embodiment of an AC utility power module of the present invention;

FIG. 3A is an illustrative schematic view showing a preferred embodiment of the transmitter of the present invention without video synchronization;

FIG. 3B is an illustrative schematic view showing a preferred embodiment of the transmitter of the present invention with video synchronization;

FIG. 4A is an illustrative schematic view showing a preferred embodiment of the receiver of the present invention without video synchronization;

FIG. 4B is an illustrative schematic view showing a preferred embodiment of the receiver of the present invention with video synchronization;

FIG. 5 is an illustrative schematic view showing a preferred embodiment of the control signal generator of the present invention;

FIG. 6 is an illustrative schematic view showing a preferred embodiment of the cable status monitor of the present invention;

FIG. 7 is an illustrative schematic view showing a preferred embodiment of the cable extender of the present invention; and

FIG. 8 is an illustrative schematic view showing a preferred embodiment of the synchronization generator of the present invention.

FIG. 9 illustrated a simplified operation of the present invention.

FIG. 10 illustrates prior art-a digital distribution system. Like reference numerals refer to like parts throughout the several views of the drawings.

### DETAILED DESCRIPTION OF THE PREFERRED EMBODIMENTS

Shown throughout the figures, the present invention is generally directed towards a low cost, highly flexible audio/video distribution system configured to connect audio and video sources to audio and video users without the need for a centralized switching and distribution mechanism.

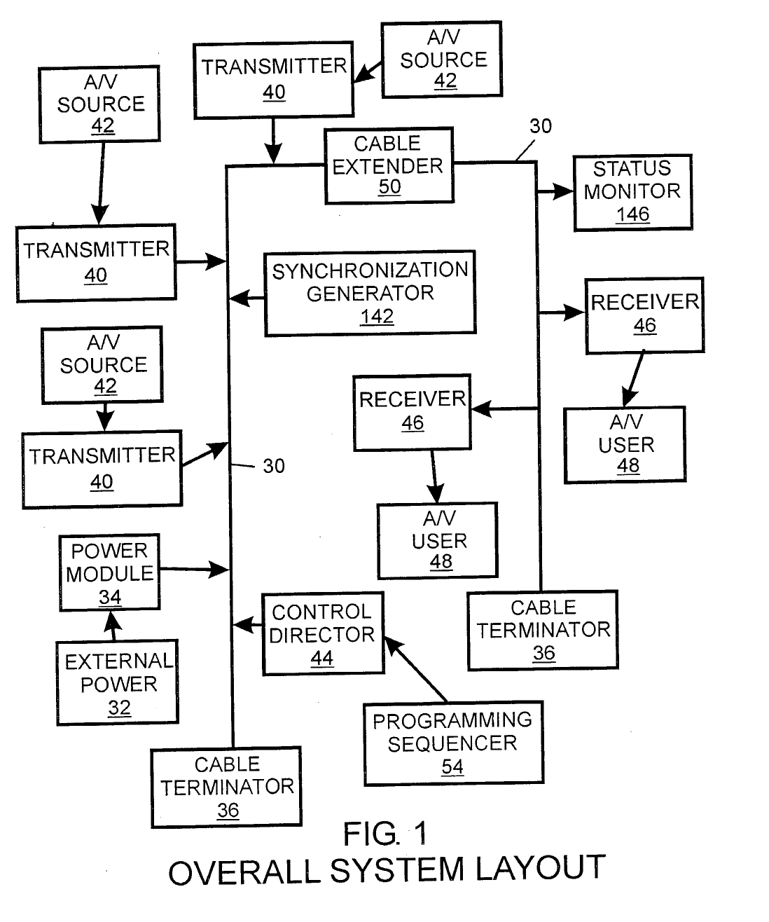

Referring primarily to FIG. 1, the overall system layout for the audio/video distribution system is shown. In the preferred embodiment of the present invention, a cable 30 is utilized as shown. The cable 30 is a passive media that may be composed in any of a wide variety of configurations. Preferably, the cable 30 will be a combination of a plurality of electrical cables or optical fiber that provides a transmission media for the audio/video, control, power, and video synchronization signals that comprise the system. The cable 30 may be terminated, if desired, at each end using the appropriate terminators 36 to match the characteristic impedance (electrical or optical) of the cable 30. As such, it is seen that the terminators 36 can be used to stabilize the signals on the cable 30.

Transmitter 40 and receiver 46 has a unique binary address. Signals from the control signal generator 44 (and programmed by the programming sequencer 54) are sent to each transmitter 40 or receiver 46 through the cable 30 to control certain properties of them. One specific property of the transmitter 40 is the ability to connect or disconnect its audio/video source to the cable. Each transmitter 40 has one of two states with respect to the cable 30: connected or disconnected. When a transmitter 40 is in the disconnected state, it represents an electrically activated non-interfering mode to the cable 30, and not physical disconnection, as in the case of a relay or an accidental unplugging of the transmitter 40 from the cable 30, for example. When the transmitter 40 is in the connected state, it has the ability to send audio/video signals to the cable 30 so that they may be sent to other devices connected to the cable 30. In this case, the connection consists of an electrically activated connection and not a physical connection. A variety of other states may also be controlled in the transmitter 40 and will be described later in this section. In the most preferred embodiment, however, only one transmitter 40 may be connected to the cable 30 at any given time.

When a transmitter 40 is connected to the cable 30, the analog audio/video signals from the transmitter 40 are sent to all components connected to the cable 30. Preferably, any receiver 46 that is connected to the cable 30 will have the ability to receive this audio/video signal. The control information, as sent by the control signal generator 44, can control states within the receiver 40, as will be described later. The transmitter 40 and receiver 46 may also contain circuitry that will take signals from the control signal generator and control auxiliary devices connected to the transmitter 40 and receiver 46.

The control signal generator 44 sends signals to each transmitter 40 to connect it to the cable 30 for some period of time so that a receiver 46 may receive its audio/video signals. Signals are then sent to the control signal generator 44 to disconnect it from the cable 30 so that another transmitter 40 may connect to the cable 30. The effect of this is to display the audio/video information from each audio/video source 42 in some programmed fashion to an activated audio/video receiver 46. An illustrative example of this would be a video surveillance with 3 video cameras (with audio) and their associated transmitters 40 located at strategic points around a building. A monitoring facility is located somewhere inside the building. This monitoring facility contains a video monitor (with audio) and a video tape recorder. These two devices (the video monitor and video tape recorder) are connected to receivers 46. These transmitters 40 and receivers 46 are connected to a common audio/video cable 30. A control signal generator 44 is also located in the monitoring facility. The control signal generator 44 may either be programmed (or manually operated) to switch the video cameras so that they may cause their analog audio/video information to be sent to the video monitor and video tape recorder.

All the components connected to the cable 30, including the audio/video sources 42, may obtain their electrical power from the cable 30. This is supplied to the cable 30 through a power module 34 that is connected to an external power source 32. Thus, in the above example, the video cameras do not have to be connected to a separate power source, but may obtain their power directly from the cable 30.

If the length of the cable 30 is longer than some critical length (as determined by the actual technology of the cable 30), a cable extender 50 may be used to boost the cable 30 signals and allow the cable 30 length to be extended. A programming sequencer 54 may be included. Programming sequencer 54 may be a programmable computing device or a manual device. The preferred function of the programmed sequencer 54 is to provide the control signal generator 44 with the commands needed to control the transmitters 40 and receivers 46. The cable status monitor 146 listens to the various signals on the cable 30 and allows them to be monitored to insure proper working of the system.

The system of the present invention may contain a video synchronization component if desired. Normally, each video frame of the video source is sent at a time interval that is determined by a clocking source contained with each audio/video source 42. Thus, the start of a video frame from one source may not coincide in time with the start of the frame from another video source. In this case, when audio/video sources 42 are switched from one to another, the video picture on the audio/video user device 48 will require some time to synchronize to the new video source 42. Audio/video user 48 may include a video monitor or station, video tape recorder, or any other suitable recording, viewing, monitoring, or storage apparatus. This time may be lengthy (1-2 seconds), but is generally not a problem for most applications, but it does limit the speed at which the audio/video sources 42 and their respective transmitters 40 may be switched. To allow the audio/video transmitters 40 to be switched at a higher rate, video synchronization may be used. This would use another signal (a synchronization signal) on the cable 30 to cause each audio/video source 42 to cause their video frames to be locked in phase with each other. When the audio/video sources 42 are switched, since the frames are synchronized, the audio/video user device 48 will not have to specifically resynchronize to the new audio/video source 42. Because of this synchronization, the audio/video sources 42 may be switched, if desired, after a one or two video frame delay.

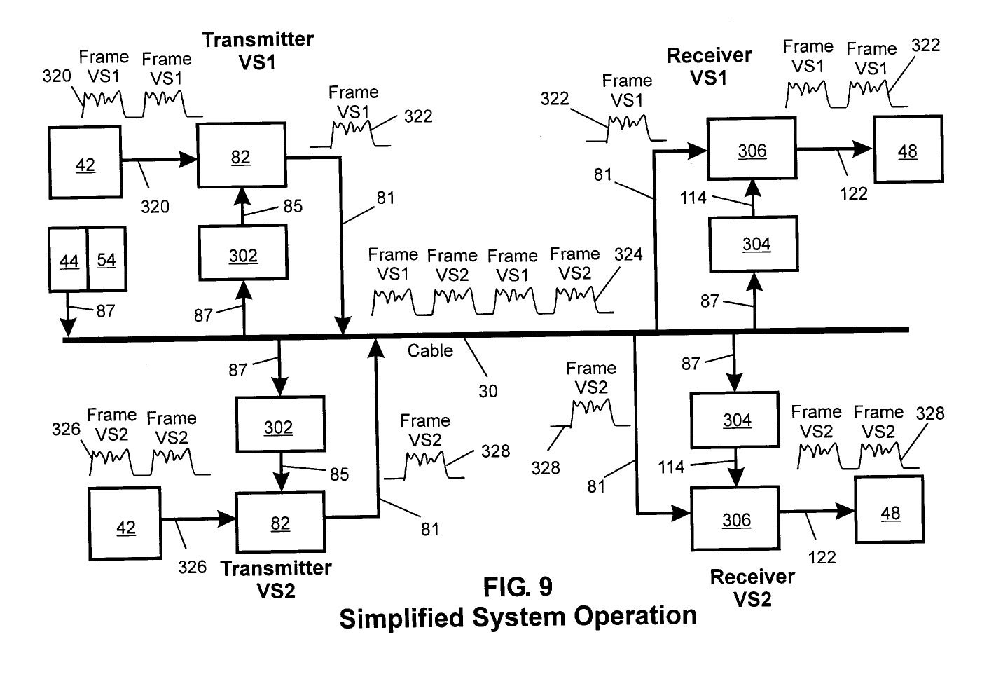

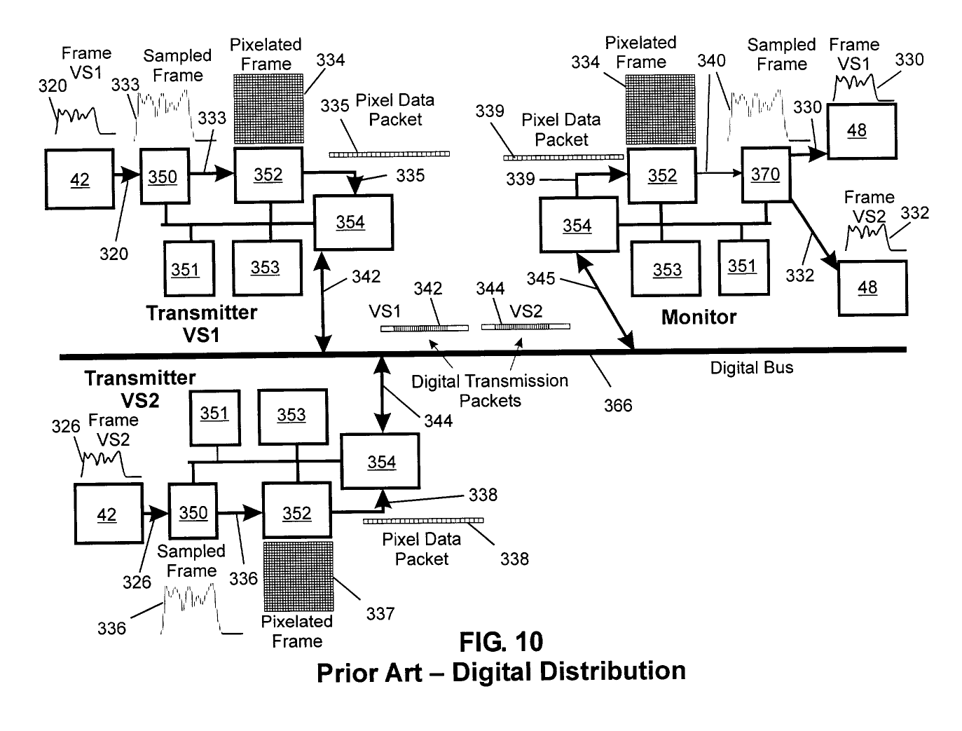

FIG. 9 provides another illustration of the operation of the present invention. FIG. 9 shows two video sources and transmitters labeled VS1 and VS2. A control signal generator 44 and programming sequencer 54 send control signals 87 over the cable to alternately allow video frames 320 from transmitter VS1 and video frames 326 from transmitter VS2 to be sent over the cable. The control signal generator 44 and programming sequencer 54 also send control signals 87 over the cable to alternately allow video frames 320 sent from transmitter VS1 to be received by receiver VS1, and video frames 326 from transmitter VS2 to be received by receiver VS2. This works as follows:

The video source 42 sends a set of video frames into a cable connect switch 82. The cable connect switch 82 is controlled by signals 85 sent from the control receiver/decoder 302, which, in turn, is controlled by cable control signals 87. The receiver is controlled by a similar control receiver/decoder 304 to turn on and off the cable receiver switch 306. The programming sequencer 54 sends a command to transmitter VS1 and receiver VS1 to turn on their cable connect switches 82 and 306. This allows a single video frame 322 from the video stream 320 sent by the video source 42 over the cable to be received by receiver VS1 so that the video frame 322 is sent to a video user 48. The programming sequencer 54 then sends a command to transmitter VS2 and receiver VS2 to turn on their cable connect switches 82 and 306 after the end of the current video frame. This allows a single video frame 328 from the video stream 326 sent by the video source 42 over the cable to be received by receiver VS2 so that the video frame 328 is sent to a video user. This has the effect of multiplexing alternating video frames 324 over the cable.

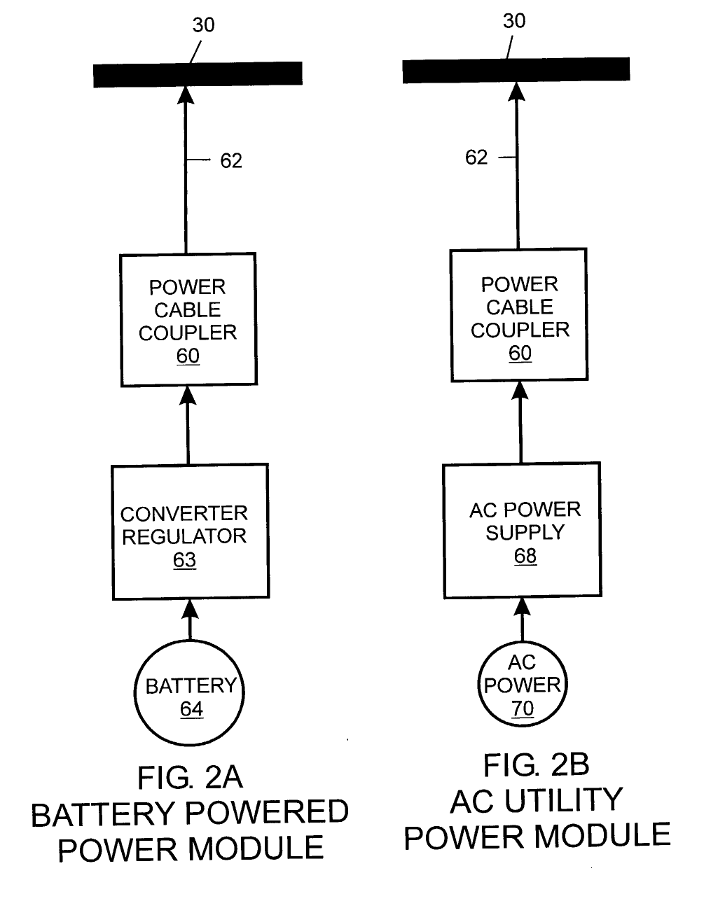

FIGS. 2A and 2B are illustrative schematic views showing power modules 34 that place electrical power on the cable 30. Electrical power is supplied from either a battery 64, AC utility power 70, or from any of a wide variety of other sources. This power is then converted via battery converter/regulator 63 or AC power supply 68 to a voltage that is significantly higher then the voltage requirements of the audio/video sources 42. It is then coupled to the cable 30 as cable power 62 using a power cable coupler 60 in such a manner that electrical current cannot flow back through either the AC power supply 68 or the battery converter/regulator 63. This is so that multiple power modules 34 may be used on the cable 30 to insure adequate power for all the audio/video user devices 48 over the entire length of the cable 30. The purpose of supplying power at a higher then needed voltage is to compensate for a drop in the voltage of the cable power 62 due to long length of the cable 30

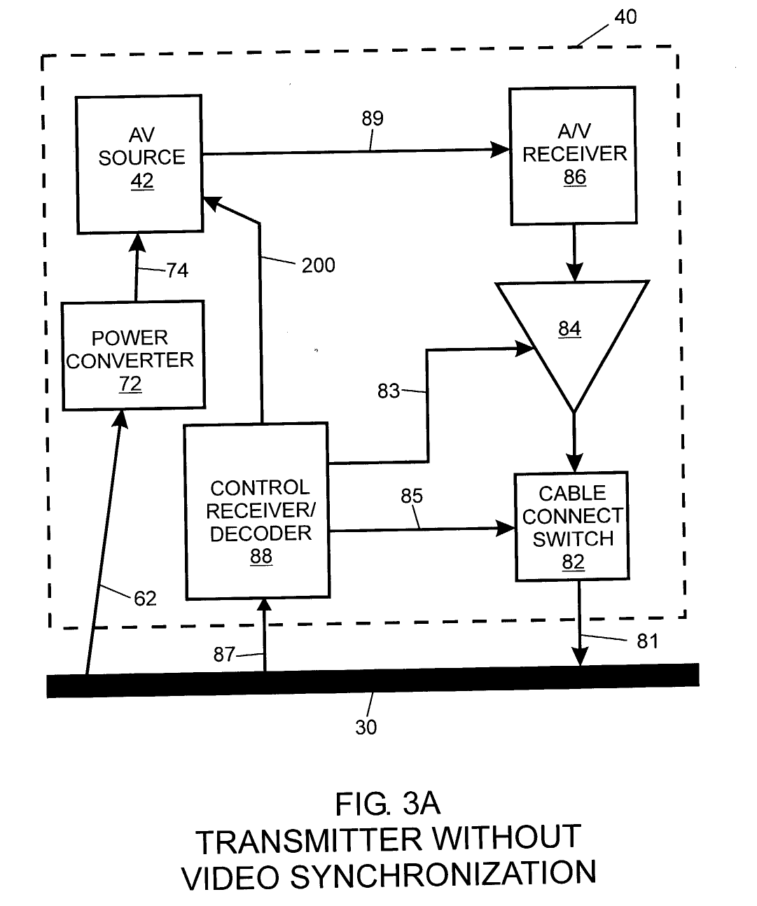

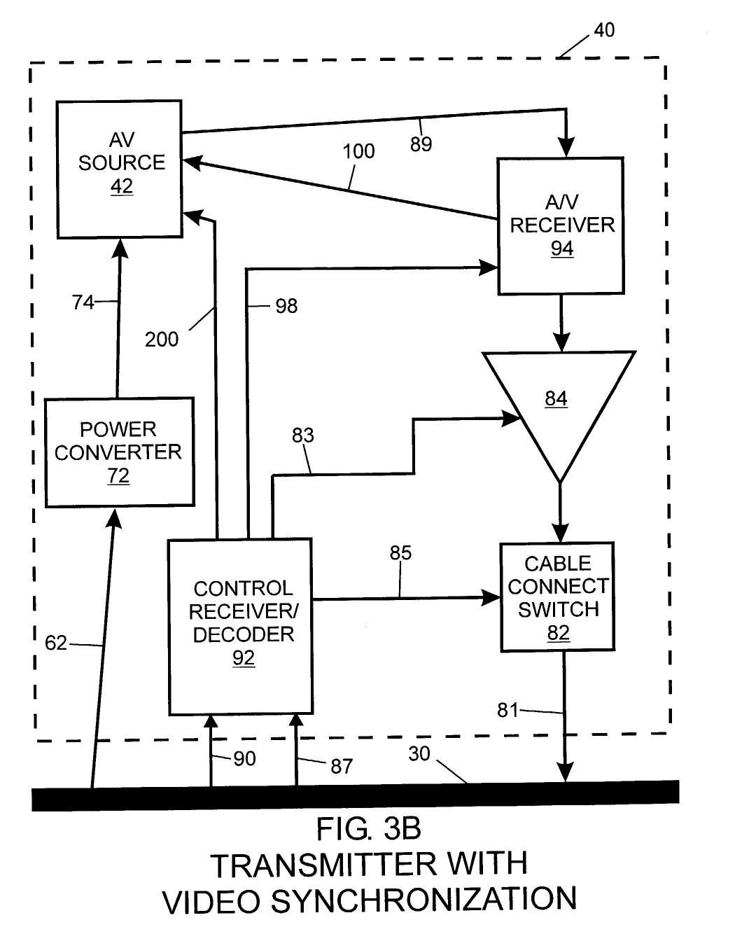

FIGS. 3A and 3B show a preferred illustrative embodiment of the transmitter 40. FIG. 3A shows the transmitter 40 without video synchronization, and FIG. 3B shows the transmitter 40 with synchronization. Cable power 62 is sent to a power converter 72, which reduces the voltage so that it is compatible with the power requirements (A/V power 74) of the audio/video source 42 and the A/V transmitter 40. Control signals 87 from the cable 30 are sent to the control receiver/decoder 88. The transmitter 40 contains a unique address, which is decoded by the control receiver/decoder 88 along with other commands destined for this address. This control receiver/decoder 88 decodes commands from the cable, and controls both cable connect/disconnect signals 85 and amplifier control signals 83. The connect/disconnect signals 85 control the cable connect switch 82. The connect switch 82 connects the audio/video in from source 89 to the cable 30 when it is in the ON state, or disconnects itself from the cable 30 when it is in the OFF state. The control receiver/decoder 88 responds to cable control signals 87 to set the cable connect/disconnect signal 85 either to ON or OFF. In addition, other audio/video signal characteristics (such as signal gain, audio or video equalization characteristics, etc.) may be controlled by the amplifier control signal 83. The amplifier control signal 83 controls the desired characteristics of the A/V amplifier and signal conditioner 84. This is a variable gain amplifier with controllable equalization parameters. It may also have other characteristics for special functions. In other, simpler implementations, if the signal from the A/V source 89 is of sufficient strength, it is not necessary for the A/V amplifier and signal conditioner 84 to be present. Audio/video information comes in to the transmitter 40 through the A/V in from source 89 and is received by the A/V receiver 86. This A/V receiver 86 simply provides correct termination of A/V in from source 89 signals. In addition, the Control Receiver/Decoder 88 has the capability of providing control signals 200 for devices that are contained within the AV Source 42. The Control Receiver/Decoder 88 optionally has the capability of receiving device control signals from the Control signal generator 140, converting these signals 200 to match the requirements of the AV Source 42, and sending these to the AV Source 42.

The signal flow through the transmitter 40 is as follows. The audio/video signals from the source come into the transmitter 40 via the A/V in from source 89 circuit and received by the A/V receiver 86. These signals can flow, if desired, through the A/V amplifier and signal conditioner 84 to the cable connect switch 82, where they then flow out over the cable 30.

For a transmitter 40 with video synchronization, a slightly different control receiver/decoder with synchronization 92 is used. This is similar to the control receiver/decoder 88, but has the additional capability of receiving the A/V synchronization signal 90 from the cable 30. This control receiver/decoder with synchronization 92 feeds the A/V synchronization signal 90 to the A/V receiver with video synchronization 94, and on to the audio/video source via the A/V synchronization signals 100. The control receiver/decoder with synchronization 92 also uses the synchronization signals 90 to synchronize the cable connect disconnect signal 85 so that the cable connect switch 82 connects the audio/video information to the cable 30 at the beginning of a video frame. The Control Receiver/Decoder 92 may incorporate timing correction to compensate for cable length. In addition, the Control Receiver/Decoder 92 has the capability of providing control signals 200 for devices that are contained within the AV Source 42. The Control Receiver/Decoder 92 optionally has the capability of receiving device control signals from the Control signal generator 140, converting these signals 200 to match the requirements of the AV Source 42, and sending these to the AV Source 42.

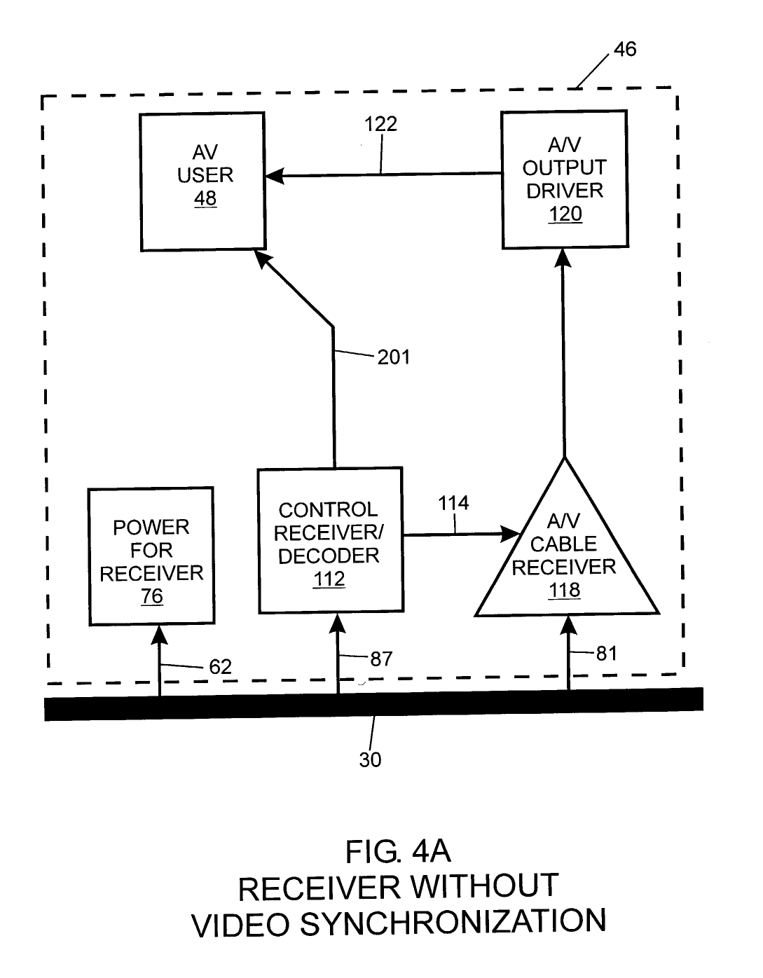

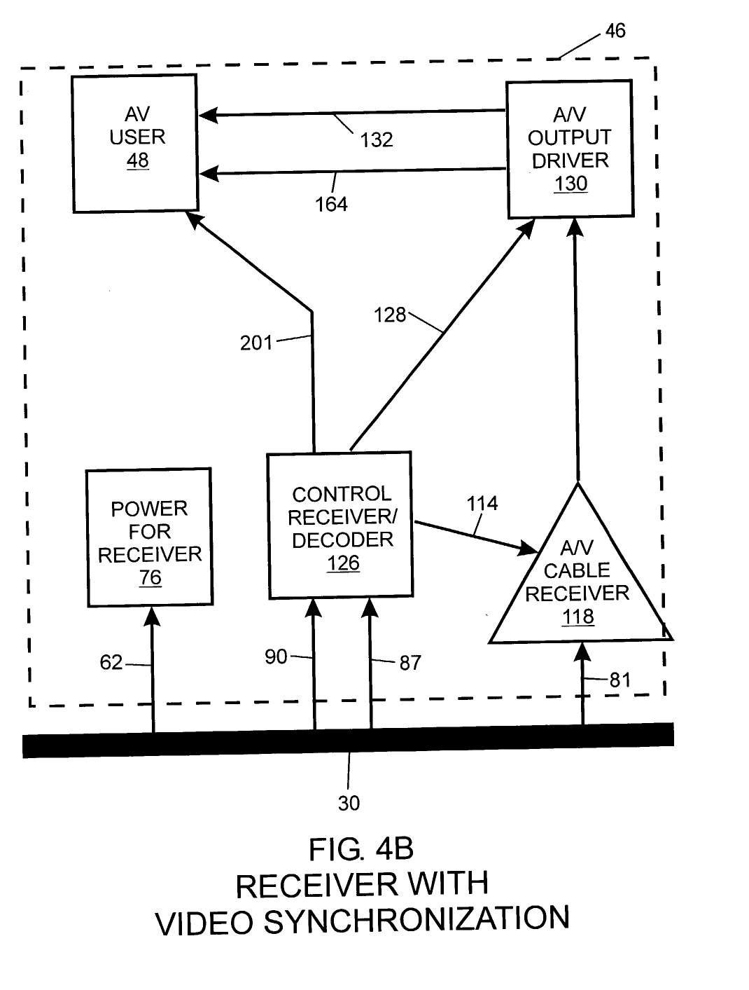

FIGS. 4A and 4B show preferred embodiments of the receiver 46. FIG. 4A shows the receiver 46 without video synchronization, and FIG. 4B shows the receiver 46 with video synchronization.

Each receiver 46 has a unique address. With reference to FIG. 4A, cable control signals 87 contain addresses and commands from the cable 30 and are decoded via the A/V control receiver/decoder 112. The control receiver/decoder 112 responds to the commands addressed to this receiver and changes the state of the receiver connect/disconnect signals 114. These signals turn the audio or video (or some other combination) ON or OFF from the A/V cable receiver 118. In addition, the Control Receiver/Decoder 112 has the capability of providing control signals 201 for devices that are contained within the AV User 48. The Control Receiver/Decoder 112 optionally has the capability of receiving device control signals from the Control signal generator 140, converting these signals 201 to match the requirements of the AV User 48, and sending these to the AV User 48. In an alternate embodiment, it may be desirable not to utilize control signals to activate/deactivate receivers, such that the receivers continuously communicate with signals transmitted over the distribution cable.

In the preferred embodiment of the present invention, the signal flow is as follows: audio/video signals 81 from the cable 30 enter the A/V cable receiver 118. The A/V cable receiver 118 continually monitors the audio/video signals 81 from the cable 30 in a fashion that does not interfere or cause loading of the cable 30. The A/V cable receiver 118 is controlled by the connect/disconnect signals 114 discussed above. The output of the A/V cable receiver 118 is sent to the A/V output driver 120, which conditions the audio/video output 122 for transmission to the A/V user.

For a receiver that uses synchronized video signals as depicted in FIG. 4B, the A/V synchronization signal 90 is received from the cable 30 and sent to a control receiver/decoder 126. This control receiver/decoder 126 not only controls the connect/disconnect signals 114, but extracts A/V synchronization signals 128 that are sent to the A/V output driver with synchronization 130. The control receiver/decoder 126 causes the receiver connect disconnect signals 114 to switch the A/V cable receiver 118 at the beginning of the video frame. The A/V output driver with synchronization 130 converts the audio and video received from the A/V cable receiver 118 and the A/V synchronization signals 128 to the proper levels and timings to be sent to the A/V user. A/V signals 132 and synchronization signals 164 are sent from the A/V output driver 130 to the A/V user 48. The control receiver/decoder 126 may incorporate timing correction to compensate for cable length. In addition, the Control Receiver/Decoder 126 has the capability of providing control signals 201 for devices that are contained within the AV User 48. The Control Receiver/Decoder 126 optionally has the capability of receiving device control signals from the Control signal generator 140, converting these signals 201 to match the requirements of the AV User 48, and sending these to the AV User 48.

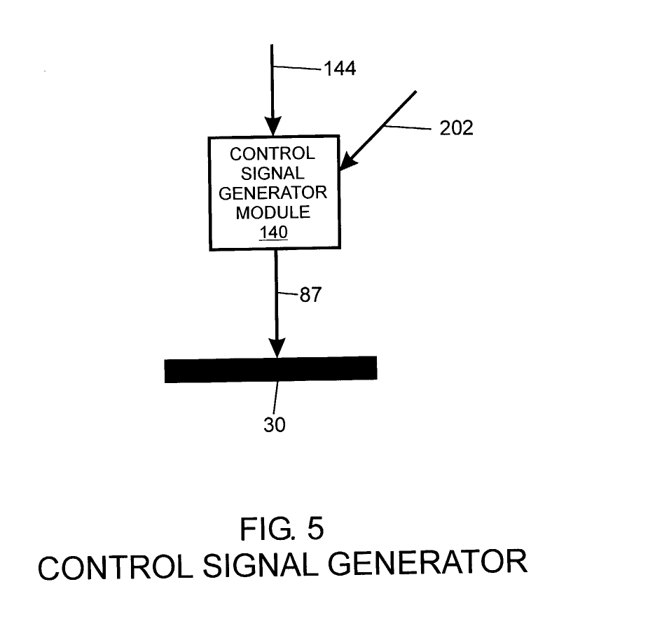

FIG. 5 shows a preferred embodiment of the control signal generator of the present invention. Control signal generator sequencing signals 144 enter the Control signal generator Module 140 as shown. This Control signal generator Module 140 converts the sequencing signals 144 into the proper cable control signals 87 for the cable 30. The Control signal generator Module 140 may change media type as well. If the control signals and audio/video portion of the cable 30 is composed of fiber optic cable, then the Control signal generator Module 140 would provide the proper conversion from electrical to optical. The Control signal generator Module 140 also provides buffering and timing, sending the cable control signals 87 over the cable 30 in the proper time sequence. In addition, the Control signal generator Module 140 has the capability of receiving device control information 202 from an external source, converting to the proper cable control signals 87, and sending it to the proper Transmitter 40 or Receiver 46.

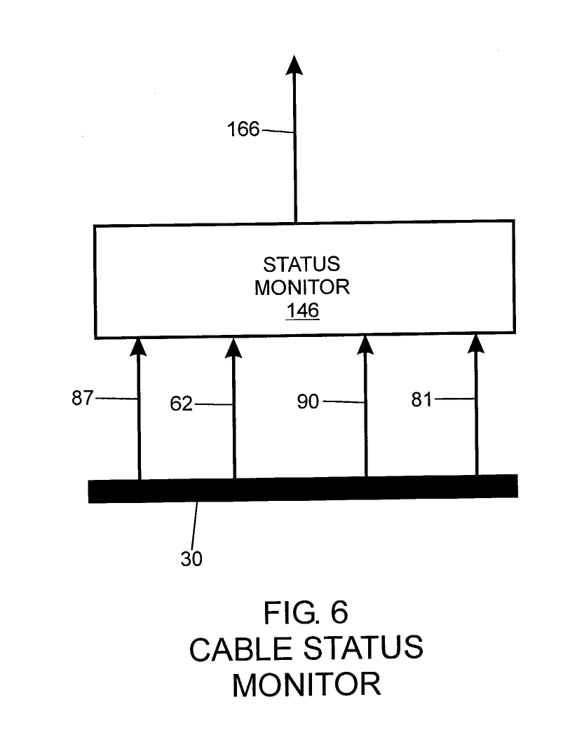

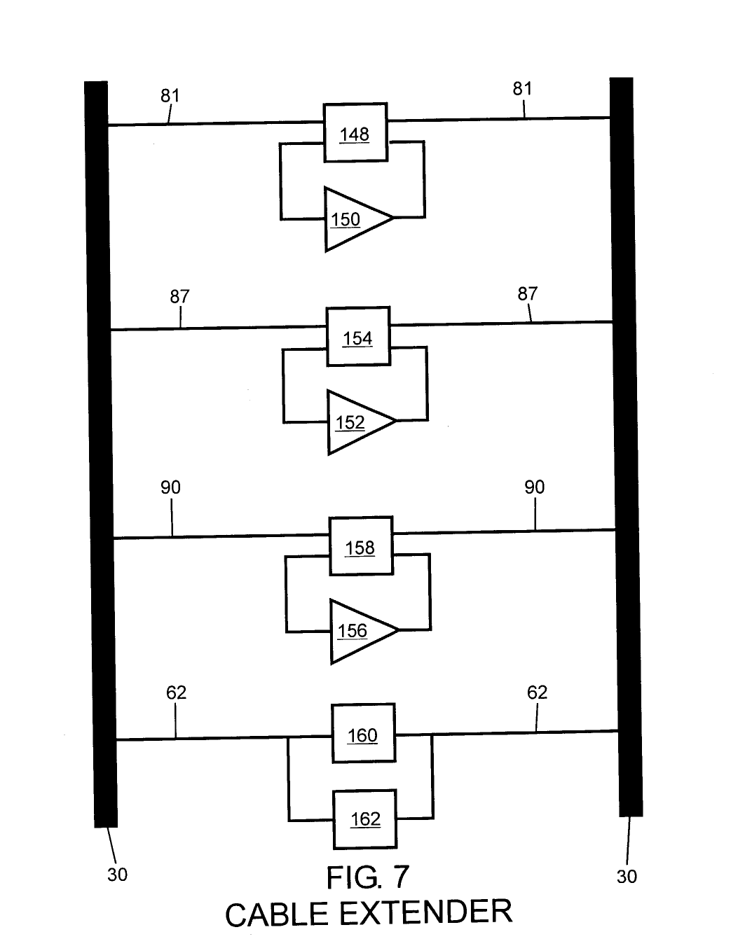

FIG. 6 shows the cable status monitor 146. This monitor samples the cable control signals 87, the cable power 62, the A/V synchronization signals 90 and the cable A/V signals 81. It compares these signals against a reference standard, and if these signals are not within tolerance, alarms are generated to indicate malfunction conditions.

FIG. 7 shows a preferred embodiment of the cable extender 50 of the present invention. The cable extender 50 contains a set of reversing switches 148, 154, and 158. Because the repeaters 150, 152, 156 perform their function in only one direction, provision must be made to reverse the “direction” of the repeaters 150, 152, 156. The cable A/V signals 81 are brought into an A/V cable repeater reversing Switch 148 and A/V cable repeater 150. The A/V cable repeater 150 amplifies and regenerates the audio/video signals on the cable 30. The purpose of the reversing switches are to provide this “reversal” so the repeaters 150, 152, 156) may be set to the proper “direction” to properly repeat or regenerate the signal. An example of this is if the audio/video source is connected to the left side of FIG. 7, the “direction” of the A/V cable repeater 150 is correct. If the audio/video source is connected to the right side of FIG. 7, the “direction” of the A/V repeater 150 must be reversed.

A/V cable repeater reversing switch 148 and A/V repeater 150 are for the cable A/V signals 81. Reversing switch 154 and control signal cable repeater 152 are for the control signals 87. Synchronization signal cable repeater reversing switch 158 and synchronization signal cable repeater 156 are for the A/V Synchronization Signals 90. For cable power 62, a cable power cutoff switch 160 is used to break the continuity of the cable power 62 so that additional cable power may be introduced onto the cable in order to bring the cable power back into tolerance. The repeater power selector switch 162 simply lets additional cable power flow either to the left or right of the cutoff switch to account for the location of the power module 34. The reversing switches may configure themselves properly by automatically sensing the signal direction on the cable.

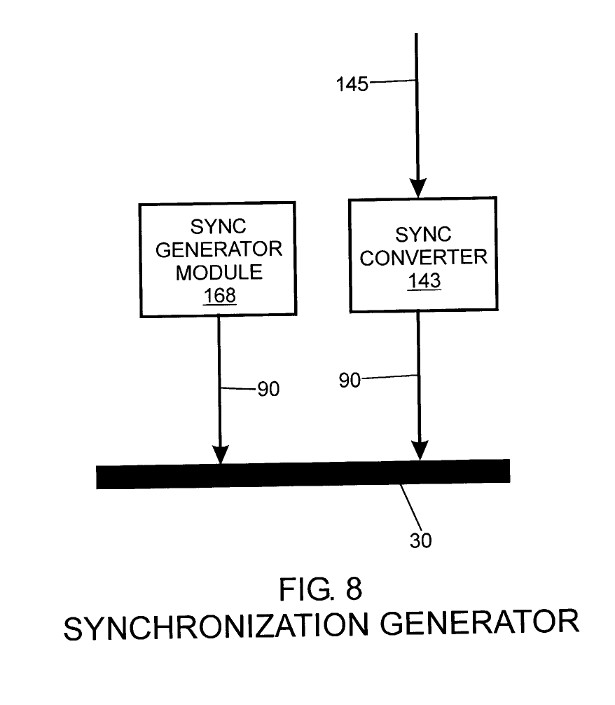

FIG. 8 shows a preferred embodiment of the synchronization generator 142. A sync generator module 168 contains a stable timing source and circuitry to place the timing signals 90 on the cable 30. The synchronization generator 142 may also obtain its timing from external source 145. A sync converter 143 converts this timing so that is compatible with the cable 30 and places these converted signals 90 on the cable 30.

In the preferred embodiment, the cable 30 is comprised of individual twisted pair copper conductors for the cable A/V signals 81, A/V synchronization signals 90, and cable control signals 87. Straight copper conductors are preferably utilized for cable power 62. However, it will be appreciated by those skilled in the art that the cable A/V signals 81, A/V synchronization signals 90, and control signals 87 may be of different technology, including coaxial cable (either individual or multiplexed), or optical fiber (either individual or multiplexed). The control signal 87 protocols and levels may be either proprietary (such as the Dallas/Maxim Semiconductor Microlan technology), or a standard protocol, including IEEE LA/V protocols. The cable power 62 may be direct current, alternating current, or some other combination.

Since many modifications, variations, and changes in detail can be made to the described preferred embodiments of the invention, it is intended that all matters in the foregoing description and shown in the accompanying drawings be interpreted as illustrative and not in a limiting sense.

Thus, the scope of the invention should be determined by the appended claims and their legal equivalents.

What I claim is:

1. An audio/video distribution system comprising:
a distribution cable;
at least one audio/video transmitter configured to receive signals from at least one audio/video source, and place said signals on said distribution cable;
at least one audio/video receiver connected to said distribution cable, said receiver configured to receive signals from said distribution cable;
a control director connected to said distribution cable and configured to control said audio/video transmitter and said receiver.

2. An audio/video distribution system as recited in claim 1, further comprising a cable status monitor connected to said distribution cable.

3. An audio/video distribution system as recited in claim 2, further comprising at least one power module configured to place electrical power on said distribution cable.

4. An audio/video distribution system as recited in claim 3, further comprising a video frame synchronization generator configured to place video frame synchronization signals on said distribution cable.

5. An audio/video distribution system as recited in claim 4, further comprising a cable extender.

6. An audio/video distribution system as recited in claim 1, wherein said distribution cable comprises at least one conductor.

7. An audio/video distribution system as recited in claim 6, further comprising at least one termination placed on said distribution cable.

8. An audio/video distribution system as recited in claim 1, wherein said audio/video transmitter comprises:
a signal input from an audio/video source;
an audio/video amplifier;
a cable connect switch; and
a transmitter control receiver/decoder.

9. An audio/video distribution system as recited in claim 8, wherein said audio/video transmitter further comprises a means of placing audio/video signals on the cable with video synchronization.

10. An audio/video distribution system as recited in claim 1, wherein said receiver comprises an audio/video cable receiver.

11. An audio/video distribution system as recited in claim 10, wherein said receiver further comprises:
an audio/video output;
an audio/video cable receiver having the capability of turning a signal from said audio/video output on or off; and
an audio/video receiver receiver/decoder.

12. An audio/video distribution system as recited in claim 11, wherein said receiver further comprises a control receiver/decoder.

13. An audio/video distribution system as recited in claim 11, wherein said receiver further comprises a means of extracting audio/video signals from the cable with video synchronization.

14. An audio/video distribution system comprising:
a distribution cable;
at least one audio/video transmitter configured to receive signals from at least one audio/video source, and place said signals on said distribution cable
at least one receiver connected to said distribution cable, said receiver configured to receive signals from said distribution cable;
a control director connected to said distribution cable and configured to control said audio/video transmitter and said receiver;
a cable status monitor connected to said distribution cable; and
at least one power module configured to place electrical power on said distribution cable.

15. An audio/video distribution system as recited in claim 14, wherein said at least one power module comprises means for adapting A/C utility power to A/C power supply for use as cable power.

16. An audio/video distribution system as recited in claim 14 wherein said at least one power module comprises means for adapting power from a battery for use as cable power.

17. An audio/video distribution system as recited in claim 14, wherein said control director further comprises a user-programmable means of controlling the transmitter and receiver connected to the audio/video cable.

18. An audio/video distribution system as recited in claim 14, further comprising a video synchronization generator.

19. An audio/video distribution system comprising:
a distribution cable;
at least one audio/video transmitter configured to receive signals from at least one audio/video source, and place said signals on said distribution cable;
at least one receiver connected to said distribution cable, said receiver configured to receive signals from said distribution cable;
a control director connected to said distribution cable and configured to control said audio/video transmitter and said receiver; and
a cable status monitor connected to said distribution cable, said cable monitor configured to extract control signals from said audio/video cable, send said control signals to a status information to external user, and provide a status of said transmitter and said receiver.

20. An audio/video distribution system as recited in claim 19, wherein said cable status monitor further comprises a means for monitoring and reporting error conditions.
